(19) United States
(12) Patent Application Publication
(10) Pub. No.: US 2010/0267357 A1
(43) Pub. Date: Oct. 21, 2010

(54) MOBILE TERMINAL HAVING IN CASE OF EMERGENCY STATE AND METHOD FOR ENTERING SUCH STATE

(76) Inventors: Tomas Holmström, Dalby (SE); Veijo Vänttinen, Lund (SE)

Correspondence Address: ERICSSON INC., 6300 LEGACY DRIVE, M/S EVR 1-C-11, PLANO, TX, 75024, US

(21) Appl. No.: 12/742,691

(22) PCT Filed: Nov. 13, 2008
(86) PCT No.: PCT/EP2008/065471

§ 371 Date: May 13, 2010

Related U.S. Application Data
(60) Provisional application No. 60/987,837, filed on Nov. 14, 2007.

(51) Int. Cl. H04M 11/04

(52) U.S. Cl. 455/404.1

(57) ABSTRACT

The invention relates to a mobile terminal having an “in case of emergency (ICE) state”. The In Case of Emergency (ICE) state is reachable by pressing a predefined code, suitably ‘I’, ‘C, ‘E’ (which on most phones correspond to ‘4’, ‘2’, ‘3’) and then an additional button e.g. the ‘Send’-, ‘Accept’- or ‘Call’ key. This action overrides ‘keylock’, ‘phone lock’ and use of ‘PIN-code’ etc similarly to the current emergency number handling. The action causes the ICE contact information to be displayed on the mobile phone or other suitable actions. If more than one contact is available in the ICE contact information storage, a list of alternative ICE contacts may be displayed. The invention also relates to a corresponding method and computer program product implementing the method.

### TECHNICAL FIELD

The present invention relates to a mobile terminal having an “in case of emergency (ICE) state”. More particularly, the invention relates to a mobile terminal having a man-machine interface (MMI) adapted to receive an ICE code for entering an ICE state in a simple manner without being blocked by various lock features. The present invention also relates to a corresponding method and computer program product implementing the method.

### BACKGROUND

In emergency situations the most common way to contact rescue services is by mobile telephones. Also the victim usually carries a mobile phone. Thus, it is recommended to store so called in case of emergency information, “ICE” information, in the phone. The ICE information is contact information for a person's closest family members, relatives or other emergency contact(s). This information can be used by ‘first responders’, such as paramedics, fire-fighters, and police officers, to get help to identify a victim and obtain important medical information etc.

Today the ICE information may be put into the phone book of the mobile phone typically by the subscriber, or handled in other proprietary mobile phone dependent ways. A standardized solution is not available and other mobile phone features such as ‘keylock’, ‘phone lock’ and use of ‘PIN-code’ could make it difficult, or even impossible, for ‘first responders’ to access the ICE information.

On the other hand, the MMI of a mobile phone should support placing of an emergency call by simply dialing an emergency number (pre-stored in the phone). The dialing of an exact emergency number overrides the lock features and also permits making a call by entering otherwise barred networks.

### PRIOR ART

As a technical reference, the international patent application published under No. WO 2007/129140 discloses a mobile telephone with a keylock function.

There is a need for a design enabling entering an ICE state in a simple manner without being blocked by various lock features in a mobile terminal.

### SUMMARY OF THE INVENTION

In a first aspect, the invention provides a mobile terminal comprising:

a control unit for controlling the operation of the terminal;
an interface unit (MMI) for receiving commands from a user to the control unit, and for displaying information;
a memory unit capable of storing contact information.

According to the invention the method the control unit is adapted to receive through the interface unit a predefined ICE code relative to “in case of emergency” information; and, in response to said ICE code, to cause the mobile terminal to enter an In Case of Emergency (ICE) state.

In one embodiment, the mobile terminal is adapted to operate with a subscriber identity module; such that, if a subscriber identity module is not connected, substantially all operations of the mobile terminal are blocked; except at least the operations to cause the mobile terminal to enter the In Case of Emergency (ICE) state.

In a further embodiment, the mobile terminal is adapted to receive a predefined lock code associated with the subscriber identity module or the mobile terminal, such that, if a lock code is not correctly entered, substantially all operations of the mobile terminal are blocked; except at least the operations to cause the mobile terminal to enter the In Case of Emergency (ICE) state.

In a further embodiment, the mobile terminal is adapted to register with a public land mobile network (PLMN) associated with the subscriber identity module or the mobile terminal, such that, if the registration with the public land mobile network is not completed, substantially all operations of the mobile terminal are blocked; except at least the operations to cause the mobile terminal to enter the In Case of Emergency (ICE) state.

In a further embodiment, the memory unit is configured to store “in case of emergency” information also comprising emergency telephone numbers, and the mobile terminal is further adapted to unblock communication operations for calling “in case of emergency” information telephone numbers using any one of all public land mobile networks available to the mobile terminal, after receiving said predefined ICE code.

In a further embodiment, if a failure condition has occurred in any state during an access procedure of the mobile terminal, such that substantially all operations of the mobile terminal are blocked; the control unit is adapted to unblock at least the operations to cause the mobile terminal to enter the In Case of Emergency (ICE) state, after receiving said predefined ICE code.

In a further embodiment, the control unit is adapted to lock substantially the whole interface unit upon user command or automatically, such that substantially all user operations of the interface unit are blocked except the unlock operations, and except at least the operations to cause the mobile terminal to enter the In Case of Emergency (ICE) state.

In a further embodiment, the control unit is adapted to cause the interface unit to present “in case of emergency” information in the In Case of Emergency (ICE) state.

In a further embodiment, the “in case of emergency” information comprises a list of alternative contacts.

In a further embodiment, the predefined ICE code comprises the buttons associated with the characters ‘I’, ‘C’, ‘E’.

In a further embodiment, the mobile terminal is adapted to permit inhibition of the display of the ICE information.

In a second aspect, the invention provides a device a method in such a mobile terminal comprising:

receiving a predefined ICE code relative to “in case of emergency” information; and, in response to said ICE code, causing the mobile terminal to enter an In Case of Emergency (ICE) state.

In one embodiment, the mobile terminal is adapted to operate with a subscriber identity module; such that, if a subscriber identity module is not connected, substantially all operations of the mobile terminal are blocked; except at least the operations to cause the mobile terminal to enter the In Case of Emergency (ICE) state.

In a further embodiment, the mobile terminal is adapted to receive a predefined lock code associated with the subscriber identity module or the mobile terminal, such that, if a lock code is not correctly entered, substantially all operations of the mobile terminal are blocked; except at least the operations to cause the mobile terminal to enter the In Case of Emergency (ICE) state.

In a further embodiment, the mobile terminal is adapted to register with a public land mobile network (PLMN) associated with the subscriber identity module or the mobile terminal, such that, if the registration with the public land mobile network is not completed, substantially all operations of the mobile terminal are blocked; except at least the operations to cause the mobile terminal to enter the In Case of Emergency (ICE) state.

In a further embodiment, the memory unit is configured to store “in case of emergency” information also comprising emergency telephone numbers, and the mobile terminal further unblocks communication operations for calling “in case of emergency” information telephone numbers using any one of all public land mobile networks available to the mobile terminal, after receiving said predefined ICE code.

In a further embodiment, if a failure condition has occurred in any state during an access procedure of the mobile terminal, such that substantially all operations of the mobile terminal are blocked; the control unit unblocks at least the operations to cause the mobile terminal to enter the In Case of Emergency (ICE) state, after receiving said predefined ICE code.

In a further embodiment, the control unit is adapted to lock substantially the whole interface unit upon user command or automatically, such that substantially all user operations of the interface unit are blocked except the unlock operations, and except at least the operations to cause the mobile terminal to enter the In Case of Emergency (ICE) state.

In a further embodiment, the control unit causes the interface unit to present “in case of emergency” information in the In Case of Emergency (ICE) state.

In a third aspect, the invention provides a computer program product comprising program code means adapted to cause a mobile terminal to be configured as mentioned above or to perform the steps as mentioned above.

Thus, by simply entering a predefined code, any person can override various locks, if active, and enter the In Case of Emergency (ICE) state. Quickly, ICE information may be presented or other actions may be permitted as set by the original user or subscriber.

The invention is defined in claims 1, 12, 21 and 22, while preferred embodiments are set forth in the dependent claims.

Embodiments of the invention will now be described more in detail in connection with the enclosed drawings.

### BRIEF DESCRIPTION OF THE DRAWINGS

FIG. 1 is a schematic block diagram of a device according to an embodiment of the invention.

FIG. 2 is a mealy graph for the mobile terminal access procedure.

FIG. 3 is a mealy graph for the In Case of Emergency access procedure.

### DETAILED DESCRIPTION OF PREFERRED EMBODIMENTS

The invention will be described with reference to a mobile telephone, also referred to as e.g. a communication device, mobile station, user terminal or just (mobile) phone.

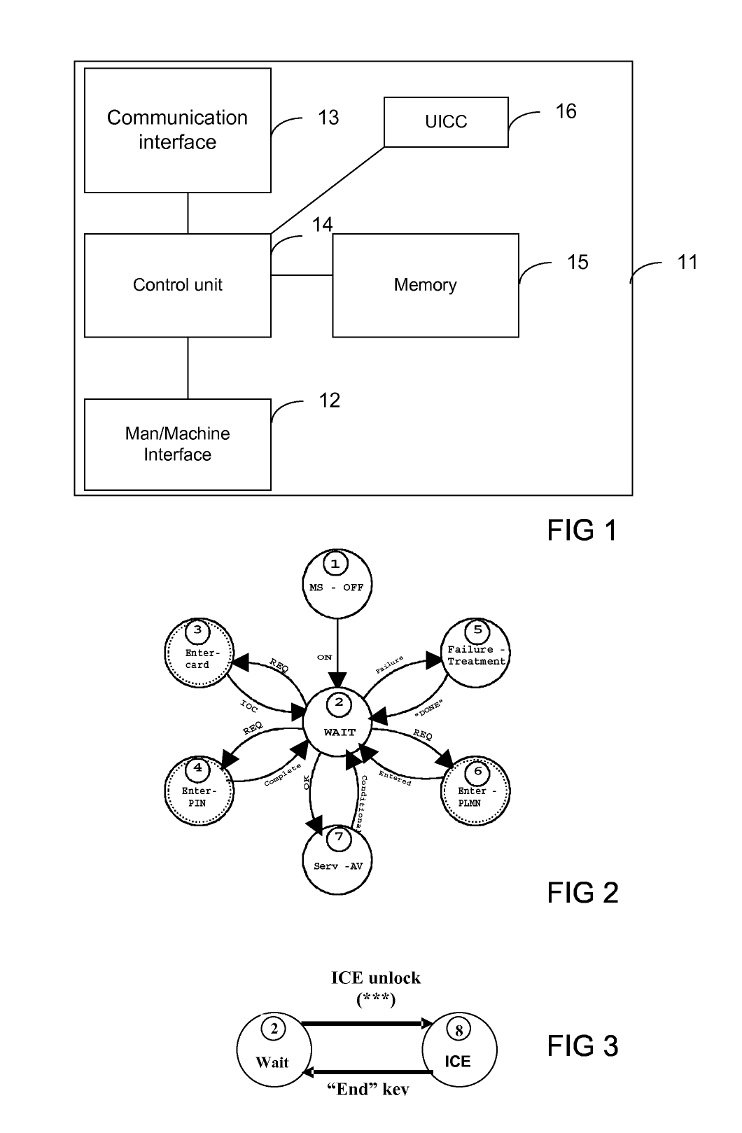

FIG. 1 illustrates schematically a device 11 according to an embodiment of the invention, such as a mobile terminal. Only parts relevant to the invention are outlined while other components may be conventional. The device 11 is provided with a MMI, a man/machine or user interface 12 comprising a keypad, voice input device, data terminal equipment, DTE, or other interface means and a display and/or a touch screen for interaction with a user, as well as communication ports (not shown).

A communication interface 13 handles the communication parts of the mobile terminal and is provided with radio units, sound processing units as well as speaker and microphone.

A control unit 14 is provided with processor power. The control unit 14 executes code and perform required calculations to handle control of the functions of the mobile terminal 11.

A memory 15 which may comprise one or more memory units of various kinds is provided to store program code as well as user data such as contact information.

The ordinary user, typically the subscriber/owner of the phone, who wants to enable display and use of ICE information, must first store it in the mobile terminal, i.e. in the memory 15. The ICE information may be put into the phone book of the mobile phone, or stored in other proprietary mobile phone dependent way using the MMI 12. Preferably, it is stored on the subscriber identity module, SIM or USIM, if available.

According to embodiments of the invention, the mobile terminal is configured to retrieve and use the ICE information. The operation may depend on the state of the mobile terminal.

FIG. 2 illustrates various states of the mobile terminal during the access procedure. Seven states exist not counting the ICE state according to embodiments of the invention.

1) MS-OFF: The mobile terminal (MS) is in OFF-condition. This means that the equipment is not active as a mobile terminal in a public land mobile network, PLMN.

2) WAIT: Waiting for the completion of the mobile terminal access conditions, which are related to the type of mobile terminal and to the PLMN, where in the mobile terminal is roaming (e.g. location updating).

3) ENTER CARD: Request for entering of a subscriber card, (e.g. when no built in subscriber identity module, SIM or USIM, is available).

4) ENTER PIN: Request for entering of the correct personal identification number, PIN, typically associated with the subscriber identity module. The mobile terminal may also be locked in other ways requiring user input, such as the conventional keylock function which may be activated automatically or manually and deactivated with a specific key combination, or a phone lock preventing use with a different subscriber identity module etc.

5) FAILURE TREATMENT: Waiting for removal an actual failure condition.

6) ENTER PLMN: Request for selection of and registration with a PLMN.

7) SERV-AV: The mobile terminal is in a ready state. PLMN services are available to the user.

### Description of the Transitions Between Mobile Terminal Access States

ON: The equipment becomes active as a mobile terminal in a PLMN.

REQ: A request for user activity.

IOC: Insertion of a subscriber card with SIM/USIM-module.

COMPLETE: The PIN has been entered.

ENTERED: A PLMN choice and registration have been done.

FAILURE: A failure condition has occurred in any other state during the mobile terminal access procedures.

CONDITIONAL: One of the conditions the mobile terminal is waiting for in WAIT state has been lost. The mobile terminal goes back to the WAIT state.

“DONE”: The mobile terminal access failure condition has been corrected.

OK: All the conditions the mobile terminal is waiting for in the WAIT state are accomplished.

In one embodiment of the invention, the MMI for access to ICE information in a mobile phone is configured to be in line with the current emergency number handling. The ICE information is reachable by entering a predetermined number sequence or code, for example pressing on the keypad the keys ‘I’, ‘C’, ‘E’ (which on most phones having twelve alpha-numeric keys correspond to ‘4’, ‘2 ’, ‘3’) and then an additional button e.g. the ‘Send’-, ‘Accept’- or ‘Call’ key. Then the mobile phone enters an In Case of Emergency (ICE) state enabling display of ICE contact information or other actions. If more than one contact is available in the ICE contact information storage, a list of alternative ICE contacts should be given.

After the sequence has been entered as described above, the ICE contact information is displayed, possibly after the ‘Send’-, ‘Accept’- or ‘Call’ key has been pressed (and released). If more than one contact is available in the ICE contact information storage in the mobile phone, a list of alternative ICE contacts can be displayed, and the possibility to select one of them should be given. If a valid subscriber identity module, such as a Universal Integrated Circuit card, UICC, generally a SIM or USIM, is present in the phone, then it shall be possible to contact the (selected) person/organization in an appropriate way (e.g. via a voice call).

Thus, the graph of FIG. 2 is completed with the graph of FIG. 3 as follows:

8) In Case of Emergency (ICE) When a predetermined code is entered (shown as ***), the mobile terminal is unlocked and ICE information is available unless the display of the ICE information has been prevented. The subscriber or other user having access to the phone's settings can decide to prevent the display of the ICE information. If the mobile terminal has been locked in the previous state, then only the ICE information is available.

ICE unlock: When a predetermined code is entered, the mobile terminal enters the In Case of Emergency (ICE) state unless the subscriber has decided to prevent the display of the ICE information.

“End” key: The mobile terminal goes back to the WAIT state.

As is conventional, emergency calls are possible in all states, except in state 1 (OFF). By simply dialing an emergency number pre-stored in the phone, placing a call is possible, even without subscriber identity module or outside the PLMN associated with an inserted subscriber identity module.

In an alternative embodiment, the choice Display ICE information is presented on the MMI 12 besides the choice Call (emergency number). As in the first embodiment, if a valid subscriber identity module SIM/UICC is present in the phone, then it shall be possible to contact the (selected) person/organization in an appropriate way (e.g. via a voice call).

In a further alternative embodiment, the ICE information number is presented in a hidden manner (Mother phone No. ****), which may be selected and dialed but not read in clear.

In a further alternative embodiment, the ICE information is not displayed but some other action is taken, such as calling a contact included in the ICE information.

The invention is also manifested in a computer program product, in other words the data entity residing in a device or stored on a medium or in a memory and intended for insertion in a device. Hence, according to another aspect, a computer program comprises program code means adapted to cause a mobile terminal to be configured to perform the steps of the method described above, when said computer program is run on the mobile terminal.

The device described herein can be implemented by means of hardware comprising several distinct elements, and/or partly or completely by means of a suitably programmed microprocessor. In the device claims enumerating several means, several of these means can be embodied by one and the same item of hardware, e.g. a suitably programmed microprocessor, one or more digital signal processors, or the like. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

The previous description of particular embodiments is provided to enable persons skilled in the art to make and use the present invention. Various modifications to these embodiments will be apparent to those skilled in the art, and the generic principles defined herein may be applied to other embodiments without departing from the scope of the invention. The present invention is not intended to be limited to the embodiments shown herein but is only limited to the claims below.

1. A mobile terminal comprising:
a control unit for controlling the operation of the terminal;
an interface unit (MMI) for receiving commands from a user to the control unit, and for displaying information;
a memory unit capable of storing contact information; and
wherein the control unit is adapted to receive through the interface unit a predefined ICE code relative to “in case of emergency” information, and, in response to said ICE code, to cause the mobile terminal to enter an In Case of Emergency (ICE) state.

2. A mobile terminal in accordance with claim 1, wherein the mobile terminal is adapted to operate with a subscriber identity module, such that, if a subscriber identity module is not connected, substantially all operations of the mobile terminal are blocked, except at least the operations to cause the mobile terminal to enter the In Case of Emergency state.

3. A mobile terminal in accordance with claim 2, wherein the mobile terminal is adapted to receive a predefined lock code associated with the subscriber identity module or the mobile terminal, such that, if a lock code is not correctly entered, substantially all operations of the mobile terminal are blocked, except at least the operations to cause the mobile terminal to enter the In Case of Emergency (ICE) state.

4. A mobile terminal in accordance with claim 1, wherein the mobile terminal is adapted to register with a public land mobile network (PLMN) associated with a subscriber identity module or the mobile terminal, such that, if the registration with the public land mobile network is not completed, substantially all operations of the mobile terminal are blocked; except at least the operations to cause the mobile terminal to enter the In Case of Emergency (ICE) state.

5. A mobile terminal in accordance with claim 4, wherein the memory unit is configured to store “in case of emergency” information also comprising emergency telephone numbers, and the mobile terminal further is adapted to unblock communication operations for calling “in case of emergency” information telephone numbers using any one of all public land mobile networks available to the mobile terminal, after receiving said predefined ICE code.

6. A mobile terminal in accordance with claim 1, wherein, if a failure condition has occurred in any state during an access procedure of the mobile terminal, such that substantially all operations of the mobile terminal are blocked; the control unit is adapted to unblock at least the operations to cause the mobile terminal to enter the In Case of Emergency (ICE) state, after receiving said predefined ICE code.

7. A mobile terminal in accordance with claim 1, wherein the control unit is adapted to lock substantially the whole interface unit upon user command or automatically, such that substantially all user operations of the interface unit are blocked except the unlock operations, and except at least the operations to cause the mobile terminal to enter the In Case of Emergency (ICE) state.

8. A mobile terminal in accordance with claim 1, wherein the control unit is adapted to cause the interface unit to present “in case of emergency” information in the In Case of Emergency (ICE) state.

9. A mobile terminal in accordance with claim 8, wherein the “in case of emergency” information comprises a list of alternative contacts.

10. A mobile terminal in accordance with claim 1, wherein the predefined ICE code comprises the buttons associated with the characters ‘I’, ‘C’, ‘E’.

11. A mobile terminal in accordance with claim 1, wherein the mobile terminal is adapted to permit inhibition of the display of the ICE information.

12. A method in a mobile terminal comprising:
receiving a predefined ICE code relative to “in case of emergency” information; and
in response to said ICE code, causing the mobile terminal to enter an In Case of Emergency (ICE) state.

13. A method in accordance with claim 12, wherein the mobile terminal is adapted to operate with a subscriber identity module, the method further comprising:
if the subscriber identity module is not connected, blocking substantially all operations of the mobile terminal, except at least the operations to cause the mobile terminal to enter the In Case of Emergency (ICE) state.

14. A method in accordance with claim 13, further comprising:
receiving a predefined lock code associated with the subscriber identity module or the mobile terminal, such that, if a lock code is not correctly entered, substantially all operations of the mobile terminal are blocked; except at least the operations to cause the mobile terminal to enter the In Case of Emergency (ICE) state.

15. A method in accordance with claim 12, further comprising:
registering with a public land mobile network (PLMN) associated with a subscriber identity module or the mobile terminal, such that, if the registration with the public land mobile network is not completed, substantially all operations of the mobile terminal are blocked; except at least the operations to cause the mobile terminal to enter the In Case of Emergency (ICE) state.

16. A method in accordance with claim 15, further comprising:
storing “in case of emergency” information also comprising emergency telephone numbers; and
unblocking communication operations for calling “in case of emergency” information telephone numbers using any one of all public land mobile networks available to the mobile terminal, after receiving said predefined ICE code.

17. A method in accordance with claim 12, further comprising:
if a failure condition has occurred in any state during an access procedure of the mobile terminal, such that substantially all operations of the mobile terminal are blocked, unblocking at least the operations to cause the mobile terminal to enter the In Case of Emergency (ICE) state, after receiving said predefined ICE code.

18. A method in accordance with claim 12, further comprising
locking substantially a whole interface unit of the mobile unit upon user command or automatically, such that substantially all user operations of the interface unit are blocked except the unlock operations, and except at least the operations to cause the mobile terminal to'enter the In Case of Emergency (ICE) state.

19. A method in accordance with claim 12,
causing an interface unit of the mobile unit to present “in case of emergency” information in the In Case of Emergency (ICE) state.

20. A method in accordance with claim 12, wherein the predefined ICE code comprises the buttons associated with the characters ‘I’, ‘C’, ‘E’.

21.-22. (canceled)
